(19) United States
(12) Patent Application Publication
(10) Pub. No.: US 2005/0205678 A1
(43) Pub. Date: Sep. 22, 2005

(54) Data carrier

(76) Inventor: Gregor Ponert, Salzburg (AT)

Correspondence Address: FLYNN THIEL BOUTELL & TANIS, P.C., 2026 RAMBLING ROAD, KALAMAZOO, MI, 49008-1631, US

(21) Appl. No.: 10/996,660

(22) Filed: Nov. 24, 2004

(30) Foreign Application Priority Data
Nov. 28, 2003 (DE) 103 56 284.2

(51) Int. Cl. G06K 5/00; G06K 19/06

(52) U.S. Cl. 235/492; 235/382

(57) ABSTRACT

A data carrier (1) has a dual interface RFID unit (2) with a contact interface (6) as a second interface as well as an antenna (3). The RFID unit (2) in the data carrier (1) is connectable to an Internet-enabled PC (9) via a standard interface, for example a USB plug (11).

This invention relates to a data carrier with a dual interface RFID unit which has a second interface besides the RFID interface and associated antenna. It also relates to a use of the data carrier.

Such dual interface data carriers are used today as chip cards which communicate contactlessly via the RF interface with a reading/writing device, on the one hand, and via the second interface, that is, the contact interface, with a chip card reader which is connected to a PC for example. Since only few PCs have a chip card reader, the known data carrier is unsuitable for general use in advance buying of tickets.

Further, wrist watches are available which have a mass memory connectable to a PC via a control unit and a USB (universal serial bus) plug. Such watches have a built-in mass memory in which data can be stored as on a diskette. Such a watch can additionally be formed with an RFID unit with an antenna for contactless data interchange with a reading/writing device.

The problem of the invention is to provide a data carrier for general use whereby the RFID unit is connectable to a PC without add-on equipment.

This is obtained according to the invention by the data carrier characterized in claim 1. Subclaims 2 to 8 state advantageous embodiments of the data carrier. Claim 9 relates to the preferred use of the inventive data carrier for booking an authorization, which is developed advantageously by claim 10.

According to the invention, the data carrier has a standard interface with which the RFID (radio frequency identification) unit is connectable to a PC for it to be read and/or written. Since this permits additional devices such as a chip card reader to be omitted, the inventive data carrier is suitable for general use.

The standard interface is preferably a USB plug. Instead, e.g. a Bluetooth interface, wireless local area network interface, infrared interface or any desired common interface can also be provided.

The USB plug can form the second interface of the dual interface RFID unit. However, the data carrier preferably has a control unit (controller) to which the dual interface RFID unit is connected via its second interface. The RFID unit can for this purpose be executed with a second interface for example as an ISO 7816 interface. In this case the control unit is connectable to a PC via a standard interface, for example with a USB plug as a standard interface. The control unit can additionally have a mass memory connected thereto for increasing the possible applications of the data carrier.

The RFID unit does not need to form a separate chip, it can also be integrated into the control unit by software or hardware.

The inventive data carrier is of portable form. It can thus be formed as a card or be integrated into a personal article of daily use, such as a key pendant, mobile phone or wrist watch. If a USB plug is used as a standard interface, the plug can be fastened to the strap with a short connection cable in the case of a wrist watch.

The inventive data carrier is in particular suitable for booking an authorization, including a service. Such an authorization can be for example an access authorization.

For this purpose the RFID unit or the control unit is connected to an Internet-enabled PC via the standard interface, that is, for example the USB plug. The PC is used to establish via the Internet a connection with a booking server for booking the authorization, that is, for loading the authorization onto the RFID unit via the Internet and the PC.

The inventive data carrier can be used to produce a secure tunnel connection between the booking server and the data carrier to exclude the danger of an attack via the Internet. For this purpose the booking server and the RFID unit each have an encryption algorithm, whereby the encryption algorithm of the booking server forms the counter-algorithm to the encryption algorithm of the RFID unit.

The encryption algorithm can be stored in the booking server or in an external unit connected to the booking server, a so-called “security chip” as software, optionally also as hardware. The counter-algorithm stored in the booking server or the external unit for the encryption algorithm stored in the RFID unit permits the communication on the Internet to be safely encrypted for warding off an attack. Symmetric or asymmetric encryption can be used.

Hereinafter the invention will be explained more precisely by way of example with reference to the enclosed schematic drawing, in which:

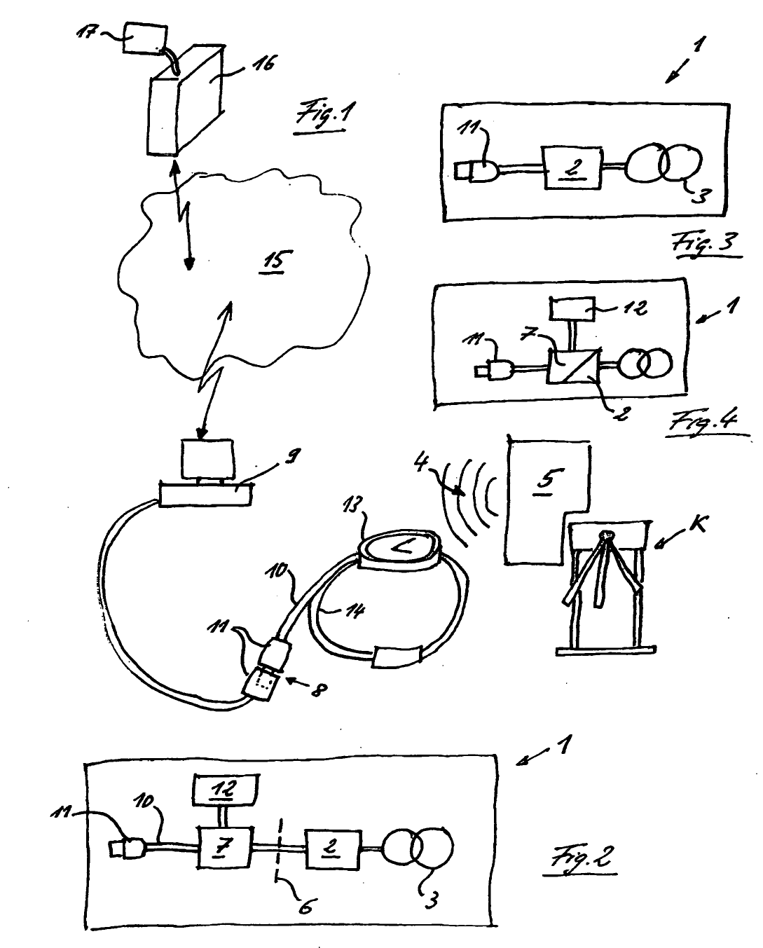

FIG. 1 shows a data carrier communicating with a booking server; and

FIGS. 2, 3 and 4 show three different embodiments of the data carrier.

According to FIG. 2, the data carrier 1 has an RFID unit 2 with an antenna 3. The RFID unit 2 consists of an RFID chip in whose memory an authorization, for example an access authorization, can be stored. As explained more precisely hereinafter in connection with FIG. 1, the data carrier 1 is integrated into the housing of the wrist watch 13. The RFID unit 2 communicates via an RFID interface 4 with a reading device 5 which likewise has an antenna (not shown). The reading device 4 actuates an access control device K formed e.g. as a turnstile, for example at a recreational facility such as a ski lift. With an authorization stored in the RFID unit 2, the access control device K can thus be actuated, i.e. released, with the data carrier 1.

The RFID unit 2 is formed as a dual interface RFID unit, that is, it has besides the RF interface 4 for example an ISO 7816 interface as a second interface 6. Via the interface 6 the RFID unit 2 is connected to a control unit (controller) 7 which is connectable to an Internet-enabled PC 9 via a standard interface 8 according to FIG. 1. The standard interface 8 is formed by a USB plug 11 which is connected by a cable 10 to the control unit 7.

The control unit 7 is furthermore connected to a mass memory 12 for increasing the possible applications of the data carrier 1, since any other data can thus also be stored in the data carrier 1 and e.g. downloaded with a PC.

According to FIG. 1, the data carrier 1 is integrated into a wrist watch 13. The USB plug 11 with the cable 10 can be fastened to the strap 14 of the watch 13. The PC 9 communicates via the Internet 15 with a booking or advance sale server 16, so that an authorization can be booked or bought via the Internet browser and an internet page associated with the booking server 16, and stored in the RFID unit 2 via the PC 9 and the interface 8. Accounting can be done via the booking server 16 in the way known in the art.

To form a secure tunnel connection, an encryption algorithm is stored in each case in the RFID unit 2 and in the booking server 16 or an external unit 17 connected to the booking server 16, whereby the encryption algorithm stored in the booking server 16 or the unit 17 (security chip) forms the counter-algorithm to the encryption algorithm found in the RFID unit 2.

The embodiment of the data carrier 1 according to FIG. 3 differs from that according to FIG. 2 in that the control unit 7 and the memory 12 are omitted and instead the USB plug 11 is connected directly to the RFID unit 2, i.e. the second interface of the dual interface RFID unit 2 is formed with the plug 11.

The embodiment of the data carrier 1 according to FIG. 4 differs from that according to FIG. 2 substantially in that the RFID unit 2 is integrated into the control unit 7 by corresponding software and/or hardware.

1. A data carrier with a dual interface RFID unit and an antenna for the first contactless interface, and a second interface, characterized in that it has as a second interface a standard interface with which the RFID unit (2) is connectable to a PC (9).

2. A data carrier according to claim 1, characterized in that the standard interface for connection to a PC (9) is formed by a USB plug (11).

3. A data carrier according to claim 1, characterized in that the second interface of the dual interface RFID unit (2) is formed as a USB plug (11).

4. A data carrier according to claim 1, characterized in that it has a control unit (7) with which the dual interface RFID unit (2) is connected via the second interface (6).

5. A data carrier according to claims 2, characterized in that the control unit (7) is connectable to a PC (9) with a USB plug (11).

6. A data carrier according to claim 4, characterized in that a mass memory (12) is connected to the control unit (7).

7. A data carrier according to any of claims 4, characterized in that the RFID unit (2) is integrated into the control unit (7).

8. A data carrier according to claim 1, characterized in that it is formed as a wrist watch (13).

9. Use of the data carrier according to claim 1 for booking an authorization by connecting the RFID unit (2) via the standard interface (8) to a PC (9) which communicates with a booking server (16) via the Internet (15).

10. Use according to claim 9, whereby the booking server (16) and the RFID unit (2) each have an encryption algorithm, the encryption algorithm of the booking server (16) forming the counter-algorithm to the encryption algorithm of the RFID unit (2).
